(19) United States
(12) Patent Application Publication
(10) Pub. No.: US 2016/0155467 A1
(43) Pub. Date: Jun. 2, 2016

(54) MAGNETIC DISK DEVICE AND OPERATING METHOD THEREOF

(71) Applicant: KABUSHIKI KAISHA TOSHIBA, Tokyo (JP)

(72) Inventor: Jun OHTSUBO, Yokohama Kanagawa (JP)

(21) Appl. No.: 14/795,436

(22) Filed: Jul. 9, 2015

Related U.S. Application Data
(60) Provisional application No. 62/085,763, filed on Dec. 1, 2014.

(51) Int. Cl. G11B 20/10; G11B 27/36

(52) U.S. Cl. CPC G11B 20/10212; G11B 27/36; G11B 2020/10898

(57) ABSTRACT

A magnetic disk device includes a disk including a plurality of zones, each including a plurality of track groups and a controller. The controller is configured to determine that data stored in a first track group is to be rewritten to the first track group, based on a refresh threshold and a first number of times data has been written to the first track group since the last rewrite of the data stored in the first track group, rewrite the data stored in the first track group to the first track group, and change the refresh threshold based on second numbers, each of which is the number of times data has been written to a different one of the track groups in a zone including the first track group, since a last reset thereof.

### CROSS-REFERENCE TO RELATED APPLICATION

This application is based upon and claims the benefit of priority from United States Provisional Patent Application No. 62/085,763, filed Dec. 1, 2014, the entire contents of which are incorporated herein by reference.

### FIELD

An embodiment described herein relates generally to a magnetic disk device and an operating method thereof.

### BACKGROUND

A magnetic disk device has a disk for data storing, and the disk includes a plurality of tracks. When a particular track is subject to frequent data writing relative to the other tracks, an adjacent track erase (ATE) (or fringing) may occur. When the ATE occurs, data recorded in tracks adjacent to the particular track is destroyed.

One type of the magnetic disk device, to prevent the ATE, carries out an operation of a track refresh. The track refresh is an operation of rewriting data, recorded in tracks adjacent to a certain track, to the same adjacent tracks each time data has been written to the certain track a predetermined number of times.

In general, frequency of the data writing sufficient to cause the ATE depends on the operating environment (for example, the presence of vibration) of the magnetic disk device. On the other hand, performing the track refresh slows the operation speed of the magnetic disk device. It would be desirable to perform the track refresh efficiently without causing the ATE.

### BRIEF DESCRIPTION OF THE DRAWINGS

FIG. 1 is a block diagram showing an exemplary configuration of a magnetic disk device according to an embodiment.

FIG. 2 illustrates an exemplary format of a disk of the magnetic disk device shown in FIG. 1.

FIG. 3 illustrates an exemplary data structure of a zone management table stored in a RAM of the magnetic disk device shown in FIG. 1.

FIG. 4 illustrates an exemplary data structure of a track refresh (TR) threshold table stored in the RAM of the magnetic disk device shown in FIG. 1.

FIG. 5 illustrates an exemplary data structure of a write count table stored in the RAM of the magnetic disk device shown in FIG. 1.

FIG. 6 is a flowchart of an operation during data writing performed by the magnetic disk device according to the embodiment.

FIG. 7 is a detailed flowchart of TR processing in the flowchart shown in FIG. 6.

FIG. 8 is a detailed flowchart of track group (TG) count update processing in the flowchart shown in FIG. 6.

FIG. 9 is a detailed flowchart of TG count determination processing in the flowchart shown in FIG. 6.

FIG. 10 illustrates an example of a TG count in each zone.

### DETAILED DESCRIPTION

Various embodiments will be described hereinafter with reference to the accompanying drawings.

In general, according to one embodiment, a magnetic disk device includes a disk including a plurality of zones, each including a plurality of track groups and a controller. The controller is configured to determine that data stored in a first track group is to be rewritten to the first track group, based on a refresh threshold and a first number of times data has been written to the first track group since the last rewrite of the data stored in the first track group, rewrite the data stored in the first track group to the first track group, and change the refresh threshold based on second numbers, each of which is the number of times data has been written to a different one of the track groups in a zone including the first track group, since a last reset thereof.

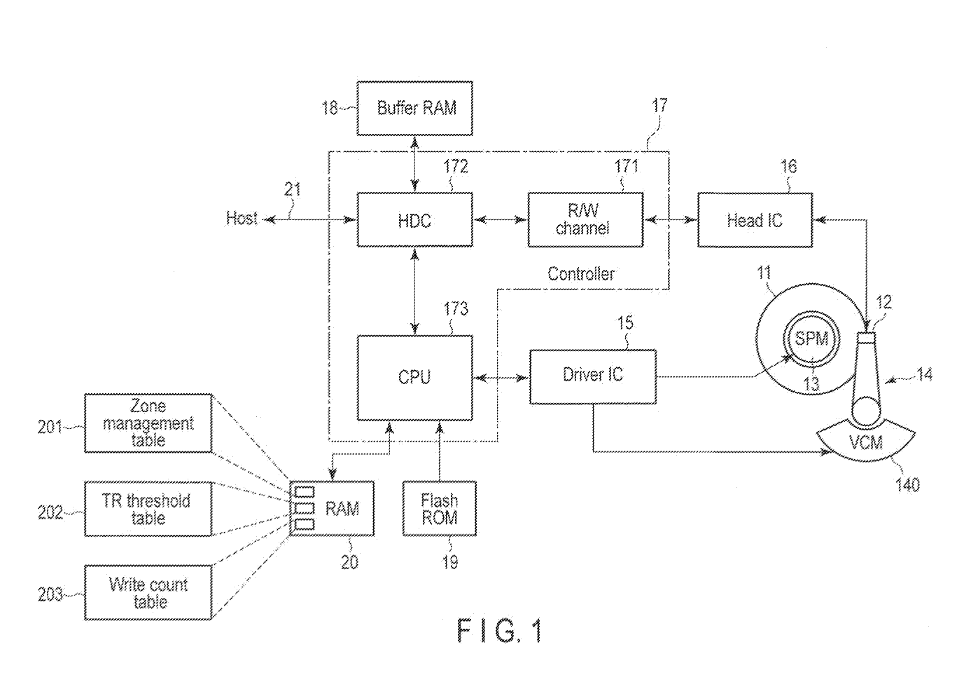

FIG. 1 is a block diagram showing an exemplary configuration of a magnetic disk device according to an embodiment. The magnetic disk device may be called as a hard disk drive (HDD). In the description below, the magnetic disk device will be referred to as an HDD. The HDD shown in FIG. 1 includes a disk (magnetic disk) 11, a head (magnetic head) 12, a spindle motor (SPM) 13, an actuator 14, a driver IC 15, a head IC 16, a controller 17, a buffer RAM 18, a flash ROM 19 and a RAM 20.

The disk 11 is a magnetic recording medium having, on one surface, a recording surface on which data is magnetically recordable. The disk 11 is spun at high speed by the SPM 13. The SPM 13 is driven by a driving current (or driving voltage) applied by the driver IC 15. The disk 11 (more specifically, its recording surface) has a plurality of concentric tracks.

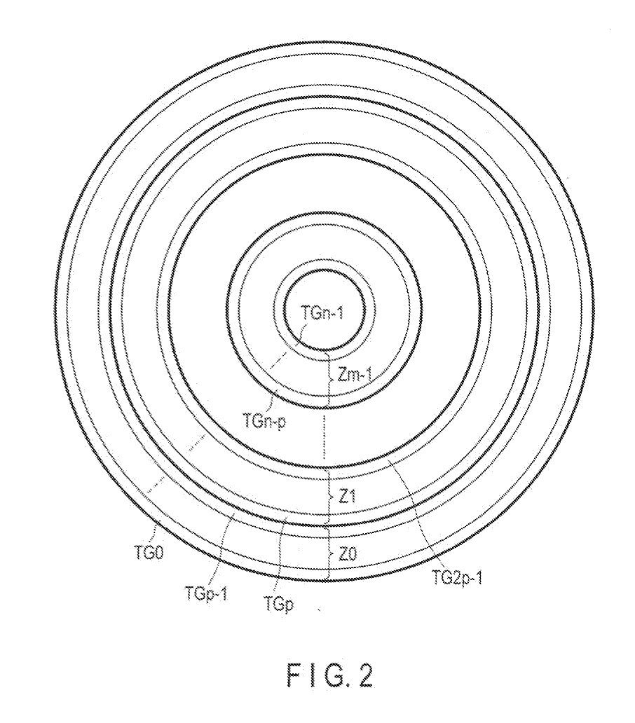

FIG. 2 shows a general outline of an exemplary format for the disk 11 used in the embodiment. As shown in FIG. 2, the recording surface of the disk 11 is divided into m concentric zones Z0, Z1, . . . , Zm−1 (arranged along the radius of the disk 11), for management. Namely, the recording surface of the disk 11 includes m zones Z0 to Zm−1. Zone numbers 0 to m−1 are allocated to the zones Z0 to Zm−1, respectively.

Similarly, the recording surface of the disk 11 is divided into n concentric track groups TG0, TG1, . . . , TGn−1 (arranged along the radius of the disk 11), for management. Namely, the recording surface of the disk 11 includes n track groups TG0 to TGn−1. Track group numbers 0 to n−1 are allocated to the track groups TG0 to TGn−1, respectively.

Each of the zones Z0 to Zm−1 includes a plurality of track groups (TGs). For instance, the zone Z0 includes p track groups TG0 to TGp−1, and the zone Z1 includes p track groups TGp to TG2p−1. Similarly, the zone Zm−1 includes p track groups TGn−p to TGn−1, assuming that n represents m·p. Thus, in the embodiment, the zones Z0 to Zm−1 each include the same number of track groups (i.e., p track groups). However, the zones Z0 to Zm−1 may not include the same number of track groups.

The track groups TG0 to TGn−1 each include a plurality of tracks (cylinders). In the embodiment, the track groups TG0 to TGn−1 each include the same number of tracks (r tracks). Accordingly, in the embodiment, the zones Z0 to Zm−1 each include the same number of tracks (r·p tracks). However, the zones Z0 to Zm−1 may not include the same number of tracks. Similarly, the track groups TG0 to TGn−1 may not include the same number of tracks.

Referring back to FIG. 1, the head 12 is disposed in accordance with the recording surface of the disk 11. The head 12 is attached to the tip of the actuator 14. When the disk 11 is spun at high speed, the head 12 floats above the disk 11. The actuator 14 has a voice coil motor (VCM) 140 serving as a driving source for the actuator 14. The VCM 140 is driven by a driving current (voltage) applied by the SVC 16. When the actuator 14 is driven by the VCM 140, this causes the head 12 to move over the disk 11 in the radial direction of the disk 11 so as to draw an arc.

The HDD 10 may include a plurality of disks unlike the configuration shown in FIG. 1. Further, the disk 11 shown in FIG. 1 may have recording surfaces on the opposite side thereof, and heads may be disposed in association with the both recording surfaces.

The driver IC 15 drives the SPM 13 and the VCM 140 under the control of the controller 17 (more specifically, a CPU 173 in the controller 17). The head IC 15 includes a head amplifier, and amplifies a signal (i.e., a read signal) read by the head 12. The head IC also includes a write driver, and converts write data from an R/W channel 171 of the controller 17 into a write current and supplies the write current to the head 12.

The controller 17 is, for example, a large-scale integrated circuit (LSI) with a plurality of elements integrated on a single chip, called a system-on-a-chip (SOC). The controller 17 includes the read/write (R/W) channel 171, a hard disk controller (HDC) 172, and the CPU 173.

The R/W channel 171 processes signals related to read/write. The R/W channel 171 digitizes a read signal, and decodes read data from the digitized data. Further, the R/W channel 171 extracts, from the digitized data, servo data necessary to position the head 12. The R/W channel 171 encodes write data.

The HDC 172 is connected to a host via a host interface 21. The HDC 172 receives commands (write and read commands, etc.) from the host. The HDC 172 controls data transfer between the host and the buffer RAM 18 and between the buffer RAM 18 and the R/W channel 171.

The CPU 173 functions as a main controller for the HDD shown in FIG. 1. In accordance with a control program, the CPU 173 controls at least part of the other elements in the HDD, including the HDC 172. In the embodiment, the control program is stored in a particular area on the disk 11, and at least part of the control program is loaded to the RAM 20 and used when a main power supply is turned on. The control program may be stored in the flash ROM 19.

The buffer RAM 18 is formed of a nonvolatile memory, such as a dynamic RAM (DRAM). The buffer RAM 18 is used to temporarily store data to be written to the disk 11 and data read from the disk 11.

The flash ROM 19 is a rewritable nonvolatile memory. In the embodiment, part of the storage area of the flash ROM 19 pre-stores an initial program loader (IPL). When, for example, the main power supply is turned on, the CPU 173 executes the IPL and loads, to the RAM 20, at least part of the control program stored on the disk 11.

Part of the storage area of the RAM 20 is used to store at least part of the control program. Another part of the storage area of the RAM 20 is used as a work area for the CPU 173. Yet, another part of the storage area of the RAM 20 is used to store a zone management table 201, a track refresh (TR) threshold table 202, and a write count table 203. The zone management table 201, the TR threshold table 202, and the write count table 203 are stored in a particular area on the disk 11, and are loaded to the RAM 20 upon the activation of the HDD shown in FIG. 1. Further, when the main power supply is cut off, or when access to the disk 11 is not performed for a predetermined period of time or more, the TR threshold table 202 and the write count table 203 in the RAM 20 are saved on the disk 11.

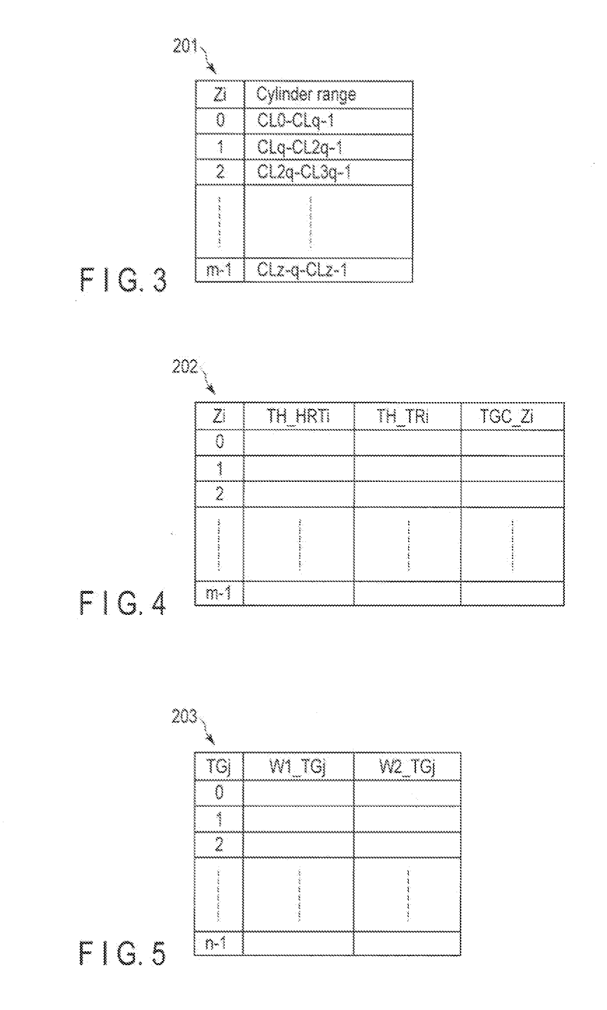

FIG. 3 shows an exemplary data structure of the zone management table 201 shown in FIG. 1. The zone management table 201 includes entries associated with respective zones Zi (i=0, 1, 2, . . . , m−1). Each entry of the zone management table 201 is indicative of the range of cylinders constituting the corresponding zone Zi, using the range of cylinder numbers allocated to the cylinders.

For instance, the zone Z0 (i=0) includes q (=r·p) cylinders CL0 to CLq−1, to which cylinder numbers 0 to q−1 are allocated, respectively. Similarly, the zone Z1 (i=1) includes q cylinders CLq to CL2q−1 to which cylinder numbers q to 2q−1 are allocated, respectively. Similarly, the zone Zm−1 (i=m−1) includes q cylinders CLz−q to CLz−1, to which cylinder numbers z−q to z−1 are allocated, respectively, assuming that z represents m·q. Thus, in the embodiment, the zones Z0 to Zm−1 each include the same number (q) of cylinders (tracks). However, the zones Z0 to Zm−1 may not include the same number of cylinders.

FIG. 4 shows an exemplary data structure of the TR threshold table 202 shown in FIG. 1. The TR threshold table 202 includes entries associated with respective zones Zi (i=0, 1, 2, . . . , m−1). Each entry of the TR threshold table 202 is used to hold reference TR (track refresh) threshold TH_HRTi, real TR threshold TH_Tri, and TG (track group) count TGC_Zi. Thus, in the embodiment, for respective zones Zi, reference TR thresholds TH_HRTi, real TR thresholds TH_Tri, and TG (track group) counts TGC_Zi are defined.

Reference TR threshold TH_HRTi is indicative of a TR threshold associated with zone Zi, and is determined in a process of manufacturing the HDD shown in FIG. 1. Reference TR threshold TH_HRTi is unchanged once the HDD is shipped.

Real TR threshold TH_TRi is indicative of a TR threshold associated with zone Zi, and is determined while the HDD is being used by a user. Real TR threshold TH_TRi is used to determine whether all tracks in track group TGj in zone Zi should be refreshed. Real TR threshold TH_TRi is set to a value (initial value) equal to reference TR threshold TH_HRTi when the HDD is shipped. After the HDD is shipped, real TR threshold TH_TRi may be changed while the user is using the HDD.

TG count TGC_Zi is indicative of the number of times data writing has been carried out on a certain track group TGj in zone Zi. TG count TGC_Zi is used to determine whether the real TR threshold TH_TRi should be set (changed) to a value different from reference TR threshold TH_HRTi. TG count TGC_Zi is incremented if write count W2_TGj associated with track group TGj is incremented and the thus-incremented write count W2_TGj satisfies a TG count update condition.

FIG. 5 shows an exemplary data structure of the write count table 203 shown in FIG. 1. The write count table 203 includes entries associated with respective track groups TGj (j=0, 1, 2, . . . , n−1). Each entry of the write count table 203 associated with track groups TGj is used to hold two write counts W1_TGj and W2_TGj.

Write count W1_TGj is indicative of the number of times data write has been carried out with respect to the track group TGj. The write count W1_TGj is used to determine whether all tracks in track group TGj should be refreshed.

Write count W2_TGj is indicative of the number of times data write has been carried out with respect to the track group TGj, like write count W1_TGj. However, a condition for initializing write count W2_TGj differs from that for write count W1_TGj, as described below. As mentioned above, write count W2_TGj is used to determine whether TG count TGC_Zi should be incremented. Since TG count TGC_Zi is used to determine whether the TR threshold should be changed, it can be said that write count W2_TGj is also used to change the TR threshold.

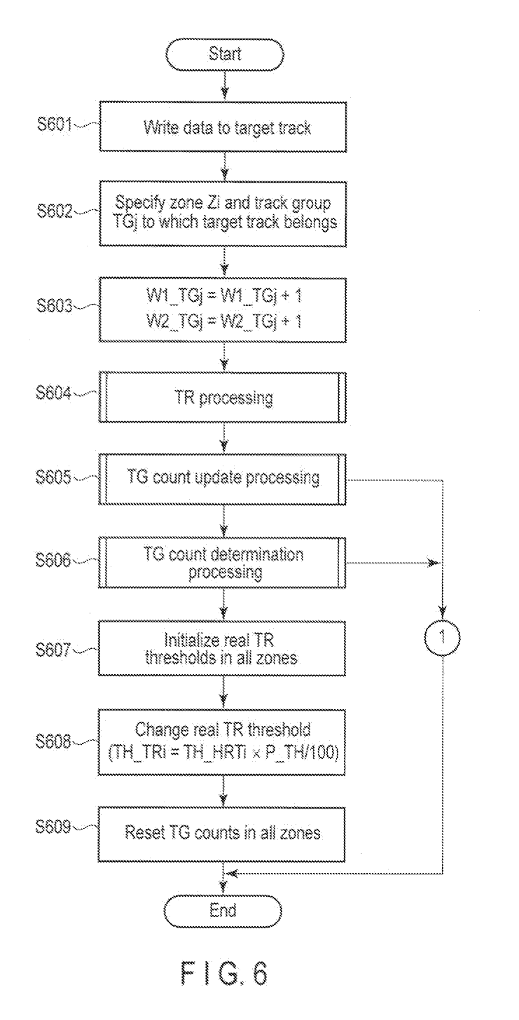

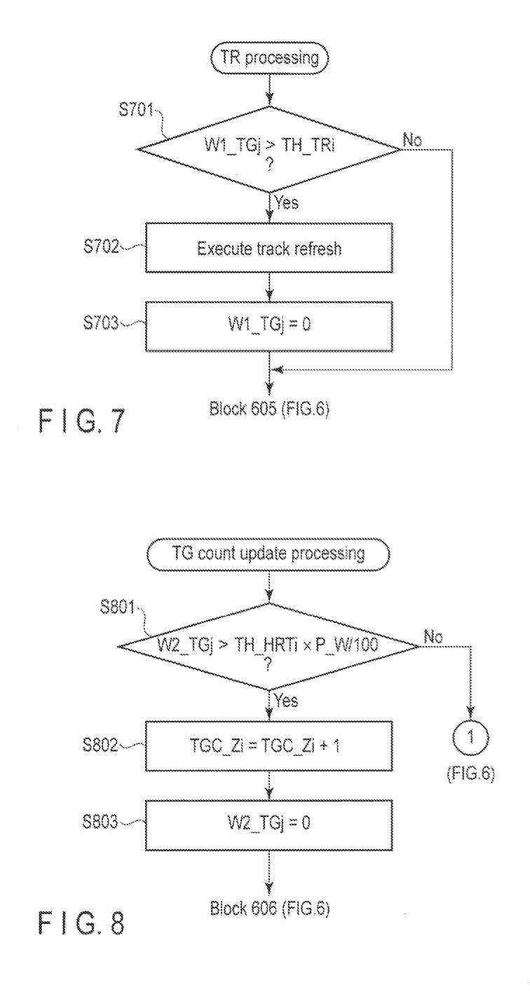

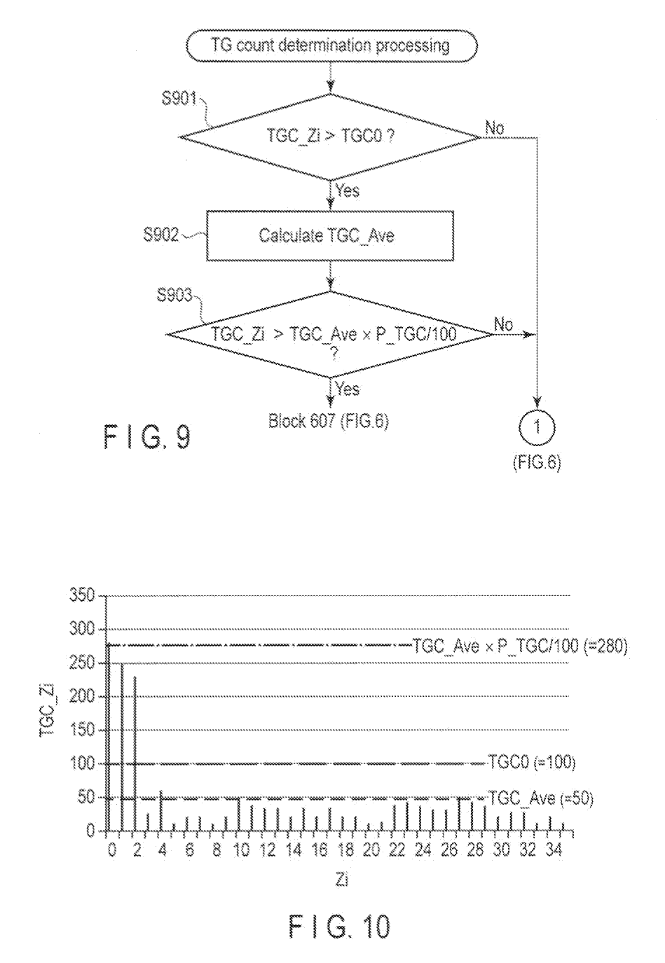

Referring mainly to FIG. 6, an operation performed during data writing in the embodiment is described below. FIG. 6 is a flowchart for explaining the operation during data writing. Assume here that the HDC 172 has received a write command and write data from the host via the host interface 21, and stores them in the buffer RAM 18. The write command received by the HDC 172 is transferred to the CPU 173. The write command includes a logical address (e.g., a logical block address) and data length information. The logical block address is indicative of a leading block of a write destination recognized by the host. The data length information indicates the length of write data by, for example, the number of blocks constituting the write data.

The CPU 173 translates a logical block address into a physical address (i.e., a physical address including a cylinder number, a head number and a sector number) indicative of a physical position on the disk 11, by referring to an address translation table. Based on the physical address and the number of blocks, the CPU 173 specifies a write area (more specifically, a write area indicated by the physical address and the number of blocks) on the disk 11, designated by the write command from the host. For simplifying the description, it is assumed that the write area (write range) is a track T having cylinder number T. In this case, the CPU 173 causes the head 12 to write the write data stored in the buffer RAM 18 to the specified track (i.e., target track) T on the disk 11, via the HDC 172 and the R/W channel 171 (S601).

Subsequently, the CPU 173 specifies track group TGj and zone Zi to which the target track T belongs, as described below (S602). First, the CPU 173 refers to a row of the zone management table 201 corresponding to the cinder number T of the target track T. As a result, the CPU 173 specifies, as zone Zi including the target track T, zone Zi associated with a cylinder number range including the cylinder number T (i.e., the cylinder range including the target track T). The track groups TG0 to TGn−1 on the disk 11 each include the same number (r) of cylinders (tracks). In the present embodiment, based on the cylinder number T of the target track T and the number r, the CPU 173 specifies, by calculation, track group TGj to which the target track T belongs.

In the present embodiment, zones Z0 to Zm−1 on the disk 11 each include the same number (q) of cylinders (tracks). Accordingly, the CPU 173 can specify zone Zi to which the target track T belongs, by calculation using the cylinder number T of the target track T and the number q (=r·p). In this case, the zone management table 201 is not always necessary. Further, the track groups TG0 to TGn−1 may not include the same number of cylinders. In this case, the CPU 173 may specify track group TGj to which the target track T belongs, referring to a track group management table indicative of cylinder ranges associated with the respective track groups. The track group management table may be used even when the track groups TG0 to TGn−1 each include the same number of cylinders.

In S603 after executing S602, the CPU 173 increments, by one, each of write counts W1_TGj and W2_TGj associated in the write count table 203 with the specified track group TGj. Then, the CPU 173 executes TR processing for refreshing all tracks in track group TGj, based on the incremented write count W1_TGj (S604).

Referring then to the flowchart of FIG. 7, TR processing will be described in detail. First, the CPU 173 determines whether the incremented write count W1_TGj exceeds real TR threshold TH_TRi associated with the specified zone Zi (S701).

If the incremented write count W1_TGj exceeds real TR threshold TH_TRi (Yes in S701), the CPU 173 determines that a condition (track refresh activation condition) for refreshing all tracks (i.e., r tracks) in track group TGj has been satisfied. At this time, the CPU 173 executes track refreshing (S702). Namely, the CPU 173 reads data from r tracks in track group TGj, and rewrites the read data to the r tracks. As a result, the r tracks in track group TGj are refreshed.

After executing track refreshing, the CPU 173 initializes write count W1_TGj to 0 (S703), thereby finishing TR processing. In this case, the CPU 173 proceeds to S605 in FIG. 6.

In contrast, if the incremented write count W1_TGj does not exceed real TR threshold TH_TRi (No in S701), the CPU 173 determines that the track refresh activation condition is not satisfied. At this time, the CPU 173 finishes TR processing (S604 in FIG. 6) without executing track refreshing, and proceeds to S605 in FIG. 6.

In S605, the CPU 173 executes TG count update processing for updating TG count TGC_Zi. In TG count update processing, TG count TGC_Zi is updated based on the incremented write count W2_TGj and reference TR threshold TH_HRTi associated with the specified zone Zi.

Referring now to the flowchart of FIG. 8, TG count update processing (S605 in FIG. 6) will be described in detail. First, the CPU 173 determines whether the ratio of the incremented write count W2_TGj to reference TR threshold TH_HRTi exceeds a third ratio (S801). The third ratio is indicative of a reference criterion associated with TG count updating, and is defined by a parameter P_W. In the embodiment, the parameter P_W is expressed by %, and is less than 100%. Namely, in S801, the CPU 173 determines whether the incremented write count W2_TGj exceeds TH_HRTi×P_W/100.

If W2_TGj exceeds TH_HRTi×P_W/100 (Yes in S801), the CPU 173 determines that a large number of data writes have been carried out with respect to track group TGj, and hence that the condition (TG count update condition) for updating (incrementing) TG count TGC_Zi is satisfied. In this case, the CPU 173 increments, by one, TG count TGC_Zi (i.e., TG count TGC_Zi set in an entry of the TR threshold table 202 associated with the specified zone Zi) (S802).

Further, the CPU 173 initializes, to 0, write count W2_TGj (write count W2_TGj associated in the write count table 203 with the specified track group TGj) (S803). After executing S802 and S803, the CPU 173 finishes TG count update processing. At this time, the CPU 173 proceeds to S606 in FIG. 6. In S606, the CPU 173 executes TG count determination processing to determine whether the incremented TG count TGC_Zi satisfies conditions for changing the TR threshold (more specifically, first and second TR threshold changing conditions).

In contrast, if W2_TGj does not exceed TH_HRTi×P_W/100 (No in S801), the CPU 173 determines that a small number of data writes have been carried out with respect to track group TGj, and hence that the condition (TG count update condition) for updating TG count TGC_Zi is not satisfied. In this case, the CPU 173 determines that since a small number of data writes have been carried out with respect to track group TGj, the condition for updating TG count TGC_Zi is not satisfied. Accordingly, the CPU 173 finishes TG count update processing (S605 in FIG. 6) without updating TG count TGC_Zi. In this case, the CPU 173 finishes the operation shown by the flowchart of FIG. 6, without changing real TR threshold TH_TRi.

Referring then to the flowchart of FIG. 9, TG count determination processing (S606 in FIG. 6) will be described in detail. The embodiment is characterized in that if the number of times data writes have been carried out with respect to the specified zone Zi is sufficiently greater than that with respect to the other zones, i.e., if data writing is concentrated on the specified zone Zi, real TR threshold TH_TRi associated with the specified zone Zi is set lower than reference TR thresholds TH_HRTi. To carry out this operation, it is sufficient if the CPU 173 determines whether the ratio of TG count TGC_Zi in zone Zi to the average value TGC_Ave of TG counts TGC_Z0 to TGC_Zm−1 in all zones Z0 to Zm−1 exceeds a first ratio. However, if each of the TG counts TGC_Z0 to TGC_Zm−1 including TG count TGC_Zi is small, it is difficult to accurately determine only from the above determination whether the number of data writes to zone Zi is sufficiently greater than those of data writes to the other zones.

In view of the above, in the embodiment, the CPU 173 first determines whether TG count TGC_Zi (more specifically, latest TG count TGC_Zi) exceeds a reference count (hereinafter referred to as a minimum TG count) TGC0 (S901). If TG count TGC_Zi does not exceed the minimum TG count TGC0 (No in S901), the CPU 173 determines that TG count TGC_Zi does not satisfy a second TR threshold changing condition, and finishes TG count determination processing. At this time, the CPU 173 finishes the operation shown in the flowchart of FIG. 6, without changing real TR threshold TH_TRi.

In contrast, if TG count TGC_Zi exceeds the minimum TG count TGC0 (Yes in S901), the CPU 173 determines that TG count TGC_Zi satisfies the second TR threshold changing condition. In this case, the CPU 173 calculates the latest average value TGC_Ave of the TG counts TGC_Z0 to TGC_Zm−1 including the latest TG count TGC_Zi.

Subsequently, the CPU 173 determines whether the ratio of TG count TGC_Zi to the calculated average value TGC_Ave exceeds a first ratio (S903). The first ratio is indicative of a determination criterion associated with TR threshold change, and is defined by a parameter P_TGC. In the embodiment, the parameter P_TGC is expressed by %, and is not less than 100%. Namely, in S903, the CPU 173 determines whether the latest TG count TGC_Zi exceeds TGC_Ave×P_TGC/100.

If TG count TGC_Zi does not exceed TGC_Ave×P_TGC/100 (No in S903), the CPU 173 determines that TG count TGC_Zi does not satisfy a first TR threshold changing condition. Namely, the CPU 173 determines that the number of times data writes have been carried out with respect to zone Zi is not significantly greater than that with respect to the other zones, and hence that the first TR threshold changing condition is not satisfied. At this time, the CPU 173 finishes TG count update processing (S606 in FIG. 6). In this case, the CPU 173 finishes the operation shown in the flowchart of FIG. 6 without changing real TR threshold TH_TRi.

In contrast, if TG count TGC_Zi exceeds TGC_Ave×P_TGC/100 (Yes in S903), the CPU 173 determines that TG count TGC_Zi satisfies the first TR threshold changing condition. Namely, the CPU 173 determines that the number of times data writes have been carried out to zone Zi is significantly greater than that with respect to the other zones, and hence that the first TR threshold changing condition is satisfied. Thus, in the embodiment, the CPU 173 determines in two stages (S901 and S903) whether TG count TGC_Zi (latest TG count TGC_Zi) satisfies the TR threshold changing condition.

When the determination result in S903 is Yes, the CPU 173 finishes TG count determination processing, and proceeds to S607 in FIG. 6. In S607, the CPU 173 initializes the real TR thresholds TH_TR0 to TH_TRm−1, set in the entries of the TR threshold table 202 associated with all zones Z0 to Zm−1, to be equal to reference TR thresholds TH_HRT0 to TH_HRTm−1, respectively.

After that, the CPU 173 changes real TR threshold TH_TRi set in the entry of the TR threshold table 202 associated with zone Zi (i.e., real TR threshold TH_TRi in zone Zi) to a value lower than reference TR threshold TH_HRTi (S608). More specifically, the CPU 173 reduces the ratio of real TR threshold TH_TRi to reference TR threshold TH_HRTi to a second ratio. The second ratio is defined by a parameter P_TH. In the embodiment, the parameter P_TH is expressed by %, and is less than 100%. Namely, in S608, the CPU 173 sets TH_HRTi×P_TH/100 as real TR threshold TH_TRi.

It is assumed here that a real TR threshold TH_TRh in a zone Zh was reduced in the preceding loop of S608. In this case, in the current loop of S607, the CPU 173 may initialize only the real TR threshold TH_TRh in the zone Zh to be equal to a reference TR threshold TH_HRTh. For this initialization, in the preceding loop of S608, it is better for the CPU 173 to record the zone number h of the zone Zh in, for example, a particular area in the RAM 20 or on the disk 11. Further, the zone number h of the zone Zh may be attached in the TR threshold table 202 as a zone number allocated to a zone whose real TR threshold was reduced in a preceding loop.

After reducing (i.e., changing) real TR threshold TH_TRi in zone Zi (S608), the CPU 173 proceeds to S609. In S609, the CPU 173 sets, to an initial value of 0, (i.e., resets), the TG count TGC_Z0 to TGC_Zm−1 set in the entries of the write count table 203 associated with all zones Z0 to Zm−1. After this processing, the CPU 173 finishes the operation shown in the flowchart of FIG. 6.

FIG. 10 shows examples of the TG counts TGC_Z0 to TGC_Zm−1 in the zones Z0 to Zm−1 at a time point Tt when m is 36 (namely, examples of the TG counts TGC_Z0 to TGC_Z35 in the zones Z0 to Z35). In FIG. 10, it is assumed that the TG count TGC_Z0 is incremented from 280 to 281 at the time point Tt. Further, the minimum TG count TGC0 is 100, and the parameter P_TGC is 560%. In addition, the average value TGC_Ave of the TG counts TGC_Z0 to TGC_Z35 at the time point Tt is 50. In this case, the determination reference TGC_Ave×P_TGC/100 is 280 (=50×560/100).

In the case of FIG. 10, only the TG count TGC_Z0 (=281) exceeds TGC_Ave×P_TGC/100 (=280) (Yes in S903 in FIG. 9). Namely, only the TG count TGC_Z0 satisfies the first TR threshold changing condition. Moreover, the TG count TGC_Z0 exceeds the minimum TG count TGC0 (=100) (Yes in S901 in FIG. 9), which means that the second TR threshold changing condition is also satisfied.

Accordingly, in the case of FIG. 10, only the real TR threshold TH_TR0 in the zone Z0 is reduced (S608). The real TR thresholds TH_TR1 to TH_TR35 of the other zones Z1 to Z35 are set to be equal to the reference TR thresholds TH_HTR1 to TH_HRT35, respectively (S607). After S607 and S608 are executed, all TG counts TGC_Z0 to TGC_Z35 are reset (S609).

As described above, in the embodiment, the real TR threshold of only one (the zone Z0 in the case of FIG. 10) of the zones Z0 to Z35 (Zm−1) is reduced. The real TR thresholds TH_TR0 to TH_TR35 of the zones Z0 to Z35 are maintained at least until one of the TG counts TGC_Z0 to TGC_Z35 has come to satisfy the TR threshold changing condition after S607 to S609 are executed.

According to the present embodiment, the CPU 173 detects zone Zi among the zones Z0 to Zm−1 on the disk 11, on which data writing is concentrated, and reduces only the TR threshold (real TR threshold TH_TRi) of the detected zone Zi. As a result, a risk that data in tracks in zone Zi will be destroyed due to concentration of data writing on zone Zi can be reduced while suppressing reduction of the performance of the HDD due to reduction of the TR threshold. Namely, in the embodiment, a margin for the reduction of ATF resistance due to an environmental difference can be increased while the reduction of the performance of the HDD is suppressed.

Further, in the embodiment, the reference TR thresholds set for the respective zones during a manufacturing process are unchanged in the TR threshold table 202. This enables real TR threshold TH_TRi to be returned to a value equal to reference TR threshold TH_HRTi (i.e., an initial value), for example, when the number of data writes to zone Zi is reduced. For the same reason, the real TR threshold is changed to a value lower than the reference TR threshold by a real TR threshold in a zone on which data writing is always concentrated, even when the use state of the HDD is changed.

<First Modification>

A first modification of the embodiment will be described. In the above embodiment, the CPU 173 changes, to a value lower than the reference TR threshold, only a real TR threshold in one zone Zi among all zones Z0 to Xm−1 on the disk 11, in which zone both the first and second TR threshold changing conditions are satisfied. In contrast, in the first modification example, the CPU 173 changes, like the real TR threshold in zone Zi, a real TR threshold in a zone in which the second TR threshold changing condition is satisfied, even if the first TR threshold changing condition is not satisfied.

In the first modification, assume that the CPU 173 has detected a TG count satisfying the second TR threshold changing condition, e.g., a TG count TGC_Zg. In this case, the CPU 173 changes a real TR threshold TH_TRg in a zone Zg associated with the TG count TGC_Zg, as well as real TR threshold TH_TRi in zone Zi. Namely, the CPU 173 changes the real TR threshold TH_TRg in the zone Zg to TH_HRTg×P_TH/100.

In the example of FIG. 10, where a TG count TGC_Z0 is higher than TGC_Ave×P_TGC/100 (and TGC0), TG counts TGC_Z1 and TGC_Z2 are higher than TGC0. Namely, the TG counts TGC_Z1 and TGC_Z2 satisfy the second TR threshold changing condition, although they do not satisfy the first TR threshold changing condition. In this case, the CPU 173 not only changes the real TR threshold TH_TR0 in the zone Z0 to TH_HRT0×P_TH/100, but also changes the real TR thresholds TH_TR1 and TH_TR2 in the zones Z1 and Z2 to TH_HRT1×P_TH/100 and TH_HRT2×P_TH/100, respectively. Thus, in the first modification, a risk of destroying data on tracks in zones on which data writing is concentrated can be further reduced, while the reduction of performance of the HDD is suppressed as much as possible. The first modification is suitable for, in particular, a use state of the HDD where data writing is concentrated on physically continuous zones.

<Second Modification>

A second modification of the embodiment will be described. In the above-described first modification, when real TR thresholds in a plurality of zones including zone Zi are reduced, they are reduced by the same amount. In contrast, the second modification is characterized in that real TR thresholds are adjusted to be reduced in accordance with the TG counts of the respective zones associated with the real TR thresholds to be reduced.

First, it is assumed that TG count TGC_Zi in zone Zi satisfies the first and second TR threshold changing conditions. Here, it is assumed also that the TG count TGC_Zg in the zone Zg does not satisfy the first TR threshold changing condition, but satisfies the second TR threshold changing condition. In this case, regarding real TR threshold TH_TRi in zone Zi, the CPU 173 reduces it to TH_HRTi×P_TH/100. In contrast, regarding the real TR threshold TH_TRg in the zone Zg, the CPU 173 adjusts the ratio of reduction of the real TR threshold TH_TRg from a reference TR threshold TH_HRTg by the ratio of the TG count TGC_Zg to TR count TGC_Zi, based on the ratio indicated by the parameter P_TH. Namely, the CPU 173 reduces the real TR threshold TH_TRg to TH_HRTg×P_TH×TGC_Zg/(TGC_Zi×100). In the second modification, the risk of destroying data on tracks in zones in which a greater number of data writes are made can be further reduced with the reduction of the HDD performance suppressed effectively.

In one or more of the above-described embodiment, the risk of destroying data on tracks in zones in which a greater number of data writes are made can be reduced while the reduction of the HDD performance is suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a disk including a plurality of zones, each including a plurality of track groups; and
a controller configured to
determine that data stored in a first track group is to be rewritten to the first track group, based on a refresh threshold and a first number of times data has been written to the first track group since the last rewrite of the data stored in the first track group,
rewrite the data stored in the first track group to the first track group, and
change the refresh threshold based on second numbers, each of which is the number of times data has been written to a different one of the track groups in a zone including the first track group, since a last reset thereof.

2. The magnetic disk device according to claim 1, wherein
the controller is further configured to
determine whether or not each of the second numbers is greater than a first predetermined value,
increment a count each time one of the second numbers is determined to be greater than the first predetermined value, and
change the refresh threshold when the count is greater than a particular value.

3. The magnetic disk device according to claim 2, wherein
the controller is further configured to
change the refresh threshold differently depending on whether or not the count is greater than a third predetermined value that is smaller than the particular value.

4. The magnetic disk device according to claim 2, wherein
the controller is further configured to reset the count in association with the refresh threshold is changed.

5. The magnetic disk device according to claim 2, wherein
the particular value is determined based on the second numbers corresponding to the track groups in all of the zones.

6. The magnetic disk device according to claim 2, wherein
the controller is further configured to increment a count each time one of the second numbers is determined to be greater than the first predetermined value, with respect to each of the plurality of zones, and
the particular value is determined based on an average of the counts.

7. The magnetic disk device according to claim 2, wherein
the first predetermined value is a value equal to an initial refresh threshold multiplied by a constant, which is greater than 0 and smaller than 1.

8. The magnetic disk device according to claim 7, further comprising:
a non-volatile memory unit, wherein
the initial refresh threshold is stored in the disk or the non-volatile memory unit.

9. The magnetic disk device according to claim 1, wherein
the refresh threshold is separately set with respect to each of the plurality of zones, and
when the refresh threshold of the zone including the first track group is changed, the refresh thresholds of all of the others zones are changed.

10. The magnetic disk device according to claim 9, wherein
the controller changes the refresh thresholds of all of the other zones to an initial refresh threshold, and the refresh threshold of the zone including the first track group is changed to a value lower than the initial refresh threshold.

11. An operating method of a magnetic disk device having a disk including a plurality of zones, each including a plurality of track groups, the method comprising:
determining whether or not data stored in a first track group is to be rewritten to the first track group, based on a refresh threshold and a first number of times data has been written to the first track group since the last rewrite of the data stored in the first track group;
rewriting the data stored in the first track group to the first track group when the data stored in the first track group is determined to be rewritten; and
changing the refresh threshold based on second numbers, each of which is the number of times data has been written to a different one of the track groups in a zone including the first track group, since a last reset thereof.

12. The method according to claim 11, further comprising:
determining whether or not each of the second numbers is greater than a first predetermined value; and
incrementing a count each time one of the second numbers is determined to be greater than the first predetermined value, wherein
the refresh threshold is changed when the count is greater than a particular value.

13. The method according to claim 12, further comprising:
determining whether or not the count is greater than a third predetermined value that is smaller than the particular value, wherein
the refresh threshold is changed differently depending on whether or not the count is greater than the third predetermined value.

14. The method according to claim 12, further comprising:
resetting the count in association with the refresh thresholds.

15. The method according to claim 12 wherein
the particular value is determined based on the second numbers corresponding to the track groups in all of the zones.

16. The method according to claim 12, further comprising:
incrementing a count each time one of the second numbers is determined to be greater than the first predetermined value, with respect to each of the plurality of zones; and
the particular value is determined based on an average of the counts.

17. The method according to claim 12, wherein
the first predetermined value is a value equal to an initial refresh threshold multiplied by a constant, which is greater than 0 and smaller than 1.

18. The method according to claim 17, further comprising:
storing the initial refresh threshold in the disk or a non-volatile memory unit.

19. The method according to claim 11, wherein the refresh threshold is separately set with respect to each of the plurality of zones, the method further comprising:
changing the refresh thresholds of all of the other zones when the refresh threshold of the zone including the first track group is changed.

20. The method according to claim 19, wherein
the refresh thresholds of all of the other zones are changed to an initial refresh threshold, and the refresh threshold of the zone including the first track group is changed to a value lower than the initial refresh threshold.
